(19) United States
(12) Patent Application Publication
(10) Pub. No.: US 2013/0097257 A1
(43) Pub. Date: Apr. 18, 2013

(54) MESSAGE TRANSMITTING AND RECEIVING SYSTEM, MESSAGE TRANSMITTING AND RECEIVING METHOD, AND COMPUTER-READABLE RECORDING MEDIUM

(71) Applicant: DeNa Co., Ltd., Tokyo (JP)

(72) Inventors: Hiroyuki JORAKUJI, Tokyo (JP); Jun Matsuura, Tokyo (JP); Masahiro Tateno, Tokyo (JP)

(73) Assignee: DeNa Co., Ltd., Tokyo (JP)

(21) Appl. No.: 13/629,101

(22) Filed: Sep. 27, 2012

(30) Foreign Application Priority Data
Sep. 27, 2011 (JP) 2011-210256

(51) Int. Cl. G06F 15/16

(52) U.S. Cl. CPC G06F 15/16
USPC 709/206

(57) ABSTRACT

The present invention aims to promote communication and provides a chat service in which users exchange messages while viewing a video. In the chat service, the messages are transmitted to users participating in the channel until an opening time period has passed, the messages being allowed to be sent and received during the opening time period. If any of the users pays a price, the opening time period of the channel is extended.

### CROSS-REFERENCE TO RELATED APPLICATIONS

The present application claims priority from Japanese Patent Application No. 2011-210256 filed on Sep. 27, 2011 which is herein incorporated by reference.

### TECHNICAL BACKGROUND

1. Technical Field

The invention relates to a message sending/receiving system, a message-sending/receiving method, and a non-transitory computer-readable storage medium.

2. Related Art

There is an effort to promote communication by exchanging messages between a plurality of users while viewing the same video. For example, Japanese Patent Application Laid-open Publication No. 2009-301404 discloses an attempt to achieve smooth communication by displaying messages so that messages relating to similar contents are noticeable.

In order to promote message exchange such as chatting, contributions of users participating in the chatting are essential. However, even if playing the same video, communication in the chatting becomes active or not depending on an atmosphere created by contents such as comments or messages of the users who participate in the chatting, videos which are playing, and the like. Thus, it was difficult to operate a virtual community so as to promote communication.

### SUMMARY

The invention has been made in view of the background mentioned above, and an advantage thereof is to provide a message sending/receiving system, a message-sending/receiving method, and a non-transitory computer-readable storage medium to promote communication.

An aspect of the invention to achieve the above advantage is a system that sends and receives a message to users belonging to a group, including:

a message transmission section that transmits the message among the users belonging to the group only until an opening time period has passed, the message being allowed to be sent and received during the opening time period;

a closing information storage section that stores, for each group, closing information for determining a closing time point at which the opening time period ends;

a payment-reception section that receives from a user a payment of a price to a specified group; and

an extension processing section that updates the closing information in response to the payment so that the closing time point corresponding to the specified group is delayed.

Further, in a message sending/receiving system according to the invention, it is acceptable that the payment-reception section acquires the group specified by the user and an amount of the price paid by the user, and the extension processing section updates the closing information according to the amount of the price so that the closing time point is delayed.

Further, in a message sending/receiving system according to the invention, it is acceptable that the message sending/receiving system further comprises a balance management section that manages, for each user, a balance of price payable by the user, the payment-reception section receives a payment request from the user, the payment request including a group specifying information that specifies the group, a user specifying information that specifies the user, and the amount of the price, and the extension processing section updates the closing information according to the amount of the price included in the payment request so that the closing time point is delayed, the closing information corresponding to the group specified by the group specifying information included in the payment request, and subtracts the amount of the price from the balance corresponding to the user specified by the user specifying information included in the payment request.

Further, in a message sending/receiving system according to the invention, it is acceptable that the message sending/receiving system further comprises a video provider section that provides a video to all of the users belonging to the group.

Further, in a message sending/receiving system according to the invention, it is acceptable that the message sending/receiving system further comprises a request-reception section that receives a request of the video from the user only until the opening time period has passed, and the video provider section provides the video to the user according to the request.

Further, in a message sending/receiving system according to the invention, it is acceptable that the message sending/receiving system connects to a user terminal of the user and to a video distribution server that distributes the video, the video distribution server is configured to transfer video data according to a video play request, and the video provider section controls the user terminal so that the video play request which specifies the video is sent to the video provider server.

Further, in a message sending/receiving system according to the invention, it is acceptable that the video distribution server is configured to transfer video data that is on and after a playback-start time if the playback-start time is set on the video play request, the playback-start time being an elapsed time that has passed from a beginning of the video, the message sending/receiving system further comprises a control-history storage section that stores a time at which distribution of the video starts, and a user management section that manages, for each group, the users belonging to the group, the video provider section controls the user terminal by sending to the user terminal a command which instructs to send to the video provider server the video play request which specifies the video, if a new user participates in the group, the video provider section reads from the control-history storage section the video-distribution-start time corresponding to that group, calculates an elapsed time that has passed from the read video-distribution-start time to the current time, and sends to a user terminal of the new user the command which instructs to send to the video provider server the video play request in which the calculated elapsed time is specified as the playback-start time of the video.

Further, another aspect of the invention provides a method for assisting in sending and receiving of a message among users belonging to a group, by a computer having a processor and a memory, including: transmitting the message to the users belonging to the group only until an opening time period has passed, the message being allowed to be sent and received during the opening time period; storing, for each group, closing information for determining a closing time point at which the opening time period ends; receiving from a user a payment of a price to a specified group; and updating the closing information in response to the payment so that the closing time point corresponding to the specified group is delayed.

Further, another aspect of the invention provides a program for assisting in sending and receiving of a message among users belonging to a group, the program causing a computer to execute the steps of: transmitting the message to the users belonging to the group only until an opening time period has passed, the message being allowed to be sent and received during the opening time period; storing, for each group, closing information for determining a closing time point at which the opening time period ends; receiving from a user a payment of a price to a specified group; and updating the closing information in response to the payment so that the closing time point corresponding to the specified group is delayed.

### BRIEF DESCRIPTION OF THE DRAWINGS

FIG. 1 is a diagram showing a screen example of a chat service of the present embodiment.

FIG. 2 is a diagram shoving an example of the overall configuration of a chat system according to the present embodiment.

FIG. 3 is a diagram showing an example of the hardware configuration of a computer used in a user terminal 10, a chat server 20, and a video distribution server 30.

FIG. 4 is a diagram showing an example of the software configuration of the video distribution server 30.

FIG. 5 is a diagram showing an example of the software configuration of the user terminal 10.

FIG. 6 is a diagram showing an example of a screen 51 which is displayed before a user participates in a channel.

FIG. 7 is a diagram showing an example of a screen 52 which is for making a contribution to a channel.

FIG. 8 is a diagram showing an example of a screen 53 which is for inputting information related to a channel.

FIG. 9 is a diagram showing an example of the software configuration of the chat server 20.

FIG. 10 is a diagram showing an example of the configuration of a participant management section 231.

FIG. 11 is a diagram showing an example of the configuration of a balance management section 232.

FIG. 12 is a diagram showing an example of the configuration of a request management section 233.

FIG. 13 is a diagram showing an example of the configuration of a playback management section 234.

FIG. 14 is a diagram showing an example of the configuration of a channel management section 235.

FIG. 15 is a diagram showing an example of the configuration of a contribution-history management section 236.

FIG. 16 is a flowchart shoving processes of the chat server 20 relating to the chat service.

### DETAILED DESCRIPTION OF THE INVENTION

The problems and solutions of the present invention will become clear through the detailed description of the present invention and the accompanying drawings.

### System Overview

The chat system related to one embodiment according to the invention will be described below. The chat system of the present embodiment provides a chat service which allows a plurality of users belonging to a certain group to view a video concurrently and to exchange messages among the users in real time. In the following description, a virtual community in which a chat service is provided, that is, a group in which the messages are exchanged is referred to as a “channel”.

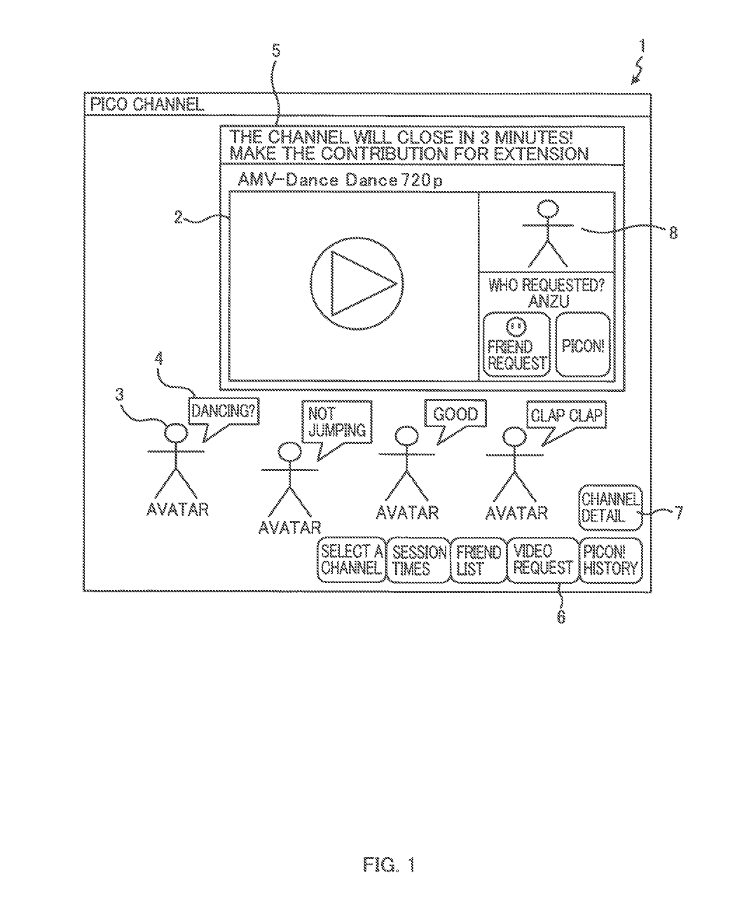

FIG. 1 is a diagram showing screen example of a chat service provided by the chat system of the present embodiment. The screen example of FIG. 1 shows how users are chatting in a channel. On the channel of the chat service of the present embodiment, a video 2 is playing on a screen 1, the alter egos (called as an avatar) of the users participating in the chat are displayed, and messages transmitted by the users are respectively output in the speech bubbles 4 of their own avatars 3. The avatars 3 can be moved on the screen according to the users' instruction.

In the chat system or the present embodiment, a period of time (hereinafter referred to as an opening time period) during which users can chat (in the following description, the term “chat” includes playing a video and exchanging messages) on a channel is limited. After the channel has been created, chatting becomes impossible when the opening time period ends. On the other hand, if users participating in the channel (the users belonging to the group) pay price, the opening time period can be extended. In the present embodiment, the price is paid with virtual currency which is provided to the users. In the present embodiment, a certain amount of the virtual currency is provided periodically.

It can be considered that users are not motivated to make payment even with virtual currency if communication in their channel is not active. Therefore, it is expected that extending the opening time period according to payments with virtual currency by the users, like the chat system of the present embodiment, allows only channels in which communication is active to continue. This makes it possible to promote communication of the whole chat service.

### System Configuration

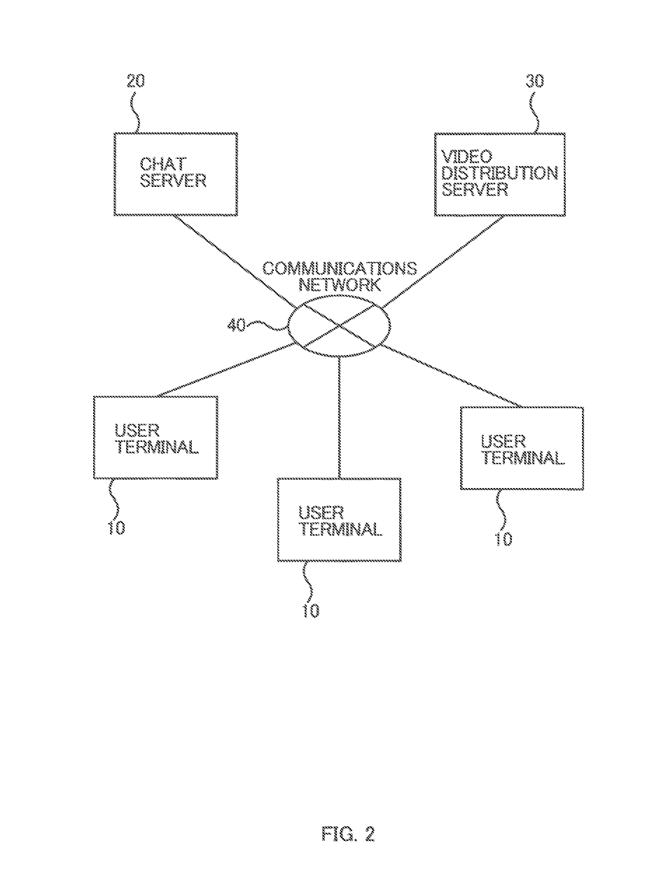

FIG. 2 is a diagram showing an example of the overall configuration of a chat system according to the present embodiment. The chat system according to the present embodiment consists of user terminal 10, a cast server 20 and a video distribution server 30. The user terminal 10, the chat server 20 and the video distribution server 30 are respectively connected to a communications network 40 so as to communicate with each other. The communications network 40 is, for example, the Internet, a LAN (LOCAL ARE NETWORK), a VAN (VALUE ADDED NETWORK) and the like configured by Ethernet (R), the public switched telephone network, the radio communication network, mobile phone network and the like.

Each of the user terminal 10 is a computer that users participating in the chat operates. The user terminal 10 is, for example, a personal computer, a workstation, a smartphone, a mobile phone, and the like.

The chat server 20 is a computer that provides a chat service, such as a workstation, a personal computer and the like.

The video distribution server 30 is a computer which provides videos, such as a workstation, a personal computer and the like. The video distribution server 30 sends a video data for playing a video as a response to a command (hereinafter referred to as a video distribution request) which is for acquiring the video data. In the present embodiment, the video data consists of a plurality of data units (hereinafter referred to as chunks); the video distribution server 30 sends video data by sending the chunks sequentially. For video distribution by the video distribution server 30, one that is used in general video distribution services may be employed.

Note that the chat server 20 and the video distribution server 30 may be realized by cloud computing in which a plurality of computers serve as a single virtual computer.

### Hardware

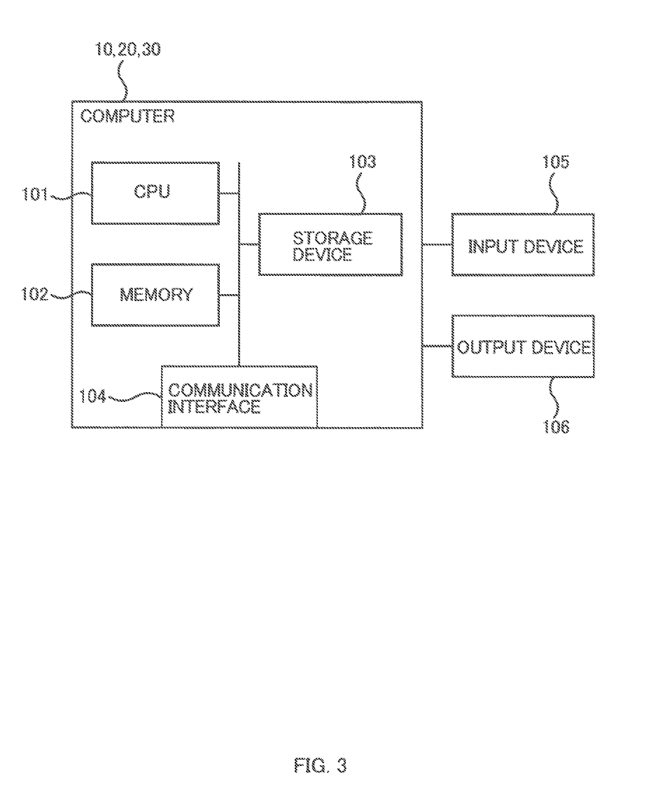

FIG. 3 is a diagram showing an example of the hardware configuration of any of the computers which realize the user terminal 10, the chat server 20 and the video distribution server 30. The user terminal 10, the chat server 20, and the video distribution server 30 include: a CPU 101; a memory 102; a storage device 103; a communication interface 104; an input device 105; and an output device 106. The storage device 103 is a device which stores various data and programs, such as a hard-disk drive, a solid state drive, a flash memory and the like. The communication interface 104 is an interface for connecting the communications network 40, namely an adapter for connecting Ethernet(R), a modem for connecting the Public Switched Telephone Network, a radio communication device for radio communication, a USB (UNIVERSAL SERIAL BUS) connector or an RS232C connector for serial communication. The input device 105 is a device for inputting data, such as a keyboard, a mouse, a touchscreen, a button, a microphone and the like. The output device 106 is a device for outputting data, such as a display, a printer, a speaker and the like.

### Video Distribution Server 30

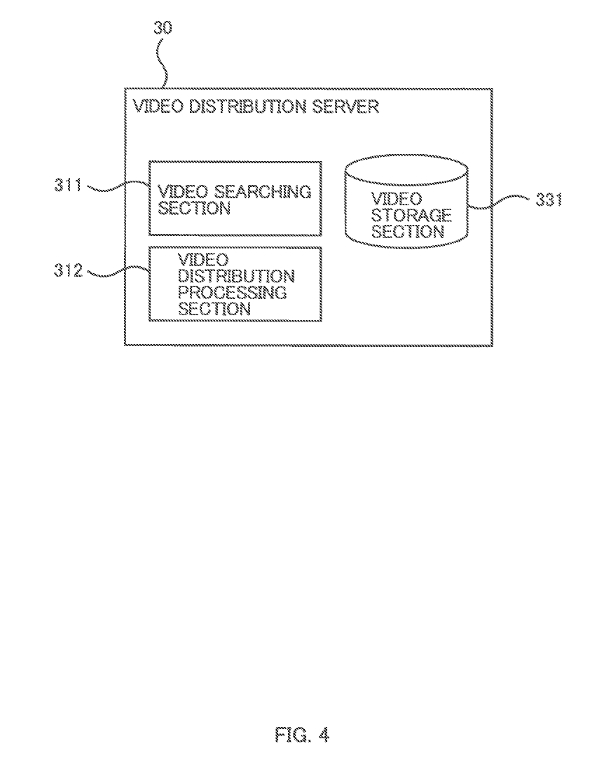

FIG. 4 is a diagram showing an example of the software configuration of the video distribution server 30. The video distribution server 30 includes a video searching section 311, a video distribution processing section 312, and a video storage section 331.

The video storage section 331 stores the following information: video data for playing a video; image data (hereinafter referred to as thumbnail data) for displaying a thumbnail image, which is a captured frame of the video; and metadata related to the video and the video data. The metadata contains the following items; identification information (hereinafter referred to as a video ID) for specifying the video; the title of the video; keywords related to the video; the name of artists who are in the video; the length of the video; the compression format of the video data; and the like. In addition to these items, the metadata can contain various items related to the video or the video data.

The video searching section 311 searches a video in response to a command (hereinafter referred to as a video search request) which is for searching a video. The video search request can be provided with a search query on items of metadata, such as a keyword, identification information of the user (hereinafter referred to as a user ID) who posted a video, an artist's name and the like. The video searching section 311 searches in the video storage section 331 metadata that matches the search query specified in the video search request. Then, the video searching section 311 sends the list of matching metadata, to the sender of the video search request.

The video distribution processing section 312 sends video data in response to a video distribution request. The video distribution request includes a video ID. The video distribution processing section 312 seeks in the video storage section 331 the video data corresponding to the video ID included in the video distribution request. Then, while reading the chunks of the retrieved video data sequentially from the head, the video distribution processing section 312 sends them to the sender of the video distribution request. To the video distribution request, the time index from which a video starts (hereinafter referred to as an offset; corresponding to the playback-start time of the invention) can be set. In the present embodiment, the chunk is video data of one second length, and the offset is time in seconds from the head of a video. If the video distribution request is provided with an offset, the video distribution processing section 312 reads chunks of the video data sequentially from the chunk which is located at a position corresponding to the offset from the start, and sends the chunks.

### User Terminal 10

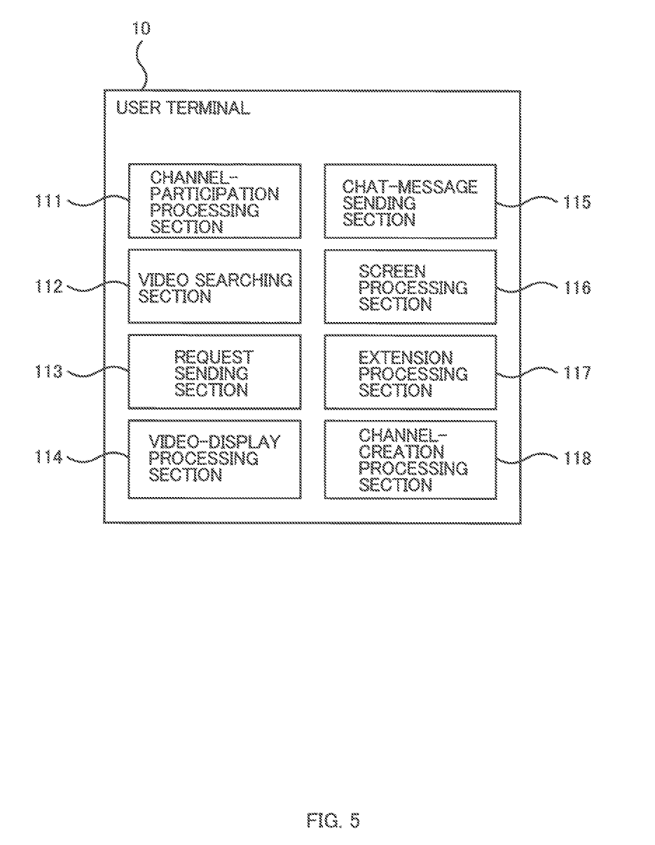

FIG. 5 is a diagram shoving an example of the software configuration of the user terminal 10. The user terminal 10 includes a channel-participation processing section 111, a video searching section 112, a request sending section 113, a video-display processing section 114, a chat-message sending section 115, a screen processing section 116, an extension processing section 117, a channel-creation processing section 118. These operational sections 111 to 118 are realized by the CPU 101 included in the user terminal 10 which reads programs stored in the storage device 103 to the memory 102 and executes it.

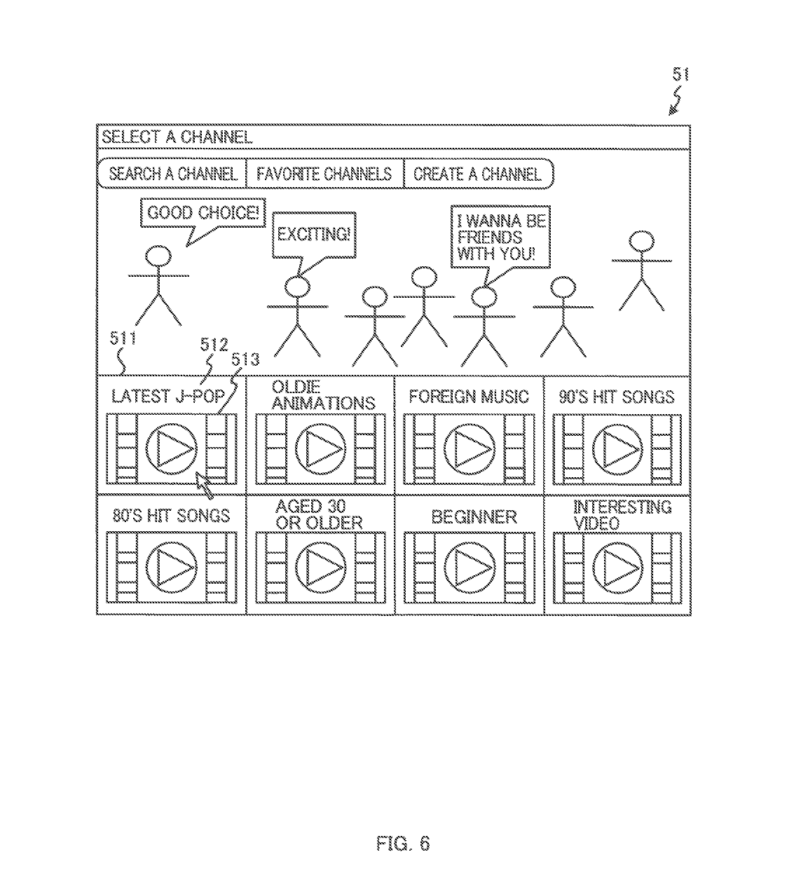

The channel-participation processing section 111 performs a process of making a user participate in a channel. FIG. 6 is a diagram showing an example of the screen 51 which is displayed before a user participates in a channel. In the example of FIG. 6, in the lower part of the screen 51, frames 511 corresponding to opened channels are listed. In each frame 511, displayed are the channel name 512 and the thumbnail 513 of the video currently playing on the channel. A user can select a channel from the frames 511 on the screen 51. On the screen 51, the channels may be displayed in a list form, or a channel may be searched using means such as a keyword. When any channel is selected on the screen 51, the channel-participation processing section 111 sets identification information of the selected channel (hereinafter referred to as a channel ID) and the user ID to a command for participating in the channel (hereinafter referred to as a channel participation request), and sends the request to the chat server 20. Thus, the user participates in the channel.

The video searching section 112 searches videos. The video searching section 112 sends to the video distribution server 30 a command to search a video (hereinafter referred to as a video search request), and thereby searches the video. As mentioned above, the video search request can be provided with a search query of various items of metadata of a video. The video searching section 112 receives a list of metadata which is sent from the video distribution server 30 in response to the video search request. The title and thumbnail of the video included in metadata can be listed on the output device 106.

The request sending section 113 sends to the chat server 20 a request of a video that a user would like to play on the channel. The request sending section 113 receives a specified video ID in thumbnail data displayed by the video searching section 112, and sends so the chat server 20 a request that is provided with the following items: the received video ID; the user ID of the user who operates the user terminal 10; the channel ID of the channel in which the user participates; and the video length contained in the metadata of the video. Note that a request may contain other items of metadata.

The video-display processing section 114 sends a video distribution request to the video distribution server 30, according to a command (hereinafter referred to as a video playback command) instructing to send a video distribution request, the command being sent from the chat server 20. The video playback command is provided with the following items: date and time at which the video playback starts (play date/time); a video ID; and an offset. In some cases, the offset is omitted. In this case, the offset is considered to be set at “0”. If the current date/time is on or after play date/time set on the video playback command, the video-display processing section 114 sends to the video distribution server 30 the video distribution request to which the video ID and the offset contained in the video playback command are set. Then, the video-display processing section 114 plays the video based on chunks sent by the video distribution server 30. Thus, in the example of FIG. 1, the video 2 plays on the screen 1. Note that the video playback processed by the video-display processing section 114 based on a video data (chunk) is a general one. If the current date/time is before the play date/time which is set on a motion playback command, the video-display processing section 114 wait till the play date/time.

The chat-message sending section 115 sends to the chat server 20 a message 4 (hereinafter referred to as a chat-message) transmitted to the channel. The chat-message sending section 115 receives an input of a chat-message from the input device 105 such as a keyboard, a mouse, a touchscreen, etc., and sends to the chat server 20 the received chat-message together with the user ID. Note that the chat-message sending section 115 can send, according to an instruction from a user, to the chat server 20 a command (hereinafter referred to as an avatar motion command) which directs the motion of the avatar corresponding to the user as a chat-message.

The screen processing section 116 performs a process of displaying the screen 1. As described below, the chat server 20 sends information (hereinafter referred to as screen information) related to displaying of the screen 1. The screen information contains, for example, motion information related to the motion of avatars 3, messages 4 transmitted by users, and the like. The screen processing section 116 displays the avatars 3, the messages 4, etc. on the screen 1 based on the screen information. Note that it is possible to set to the screen information various information to be displayed on the screen 1.

The extension processing section 117 performs a process of extending the opening time period of a channel. As mentioned above, as the opening time period passes, the chat server 20 ceases to send the screen information related to one channel, which makes it impossible to exchange chat-messages in the channel and to play videos. However, if a user pays virtual currency, the opening time period extends. In the following description, user's paying price for extending the opening time period of a channel is referred to as “contribution” to that channel.

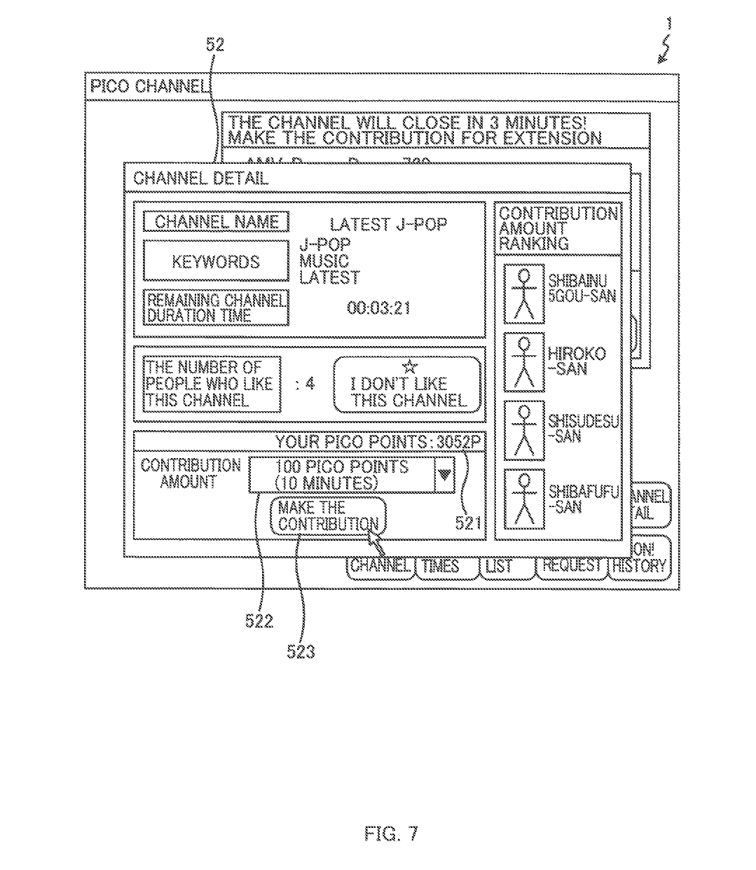

FIG. 7 is a diagram showing an example of the screen 52 which is for making a contribution. In the example illustrated in FIG. 7, the screen 52 is displayed as a pop-up window on the screen 1. However, a new screen independent of the screen 1 may be displayed. When channel detail button 7 on the screen 1 is pushed, the screen 52 is displayed. On the screen 52, the balance 521 of virtual currency allocated to a user is displayed together with various information related to the channel. Each user can contribute an amount equal to or less than his/her balance. When a contribution amount is selected from a pull-down list 522 and a button 523 is pushed, the extension processing section 117 provides the following items to a command (hereinafter referred to as an extension request) for requesting the extension of the opening time period; the contribution amount selected using the pull-down list 522; the user ID indicating the user; and the channel ID indicating the channel in which the user currently participates. Then, the extension processing section 117 sends the command to the chat server 20. According to the contribution amount, the opening time period is extended. In the present embodiment, when a virtual currency of 100 units is paid, the opening time period is extended by 10 minutes. However, it is possible to freely set the correspondence between an amount of virtual currency and the extension length of the opening time period.

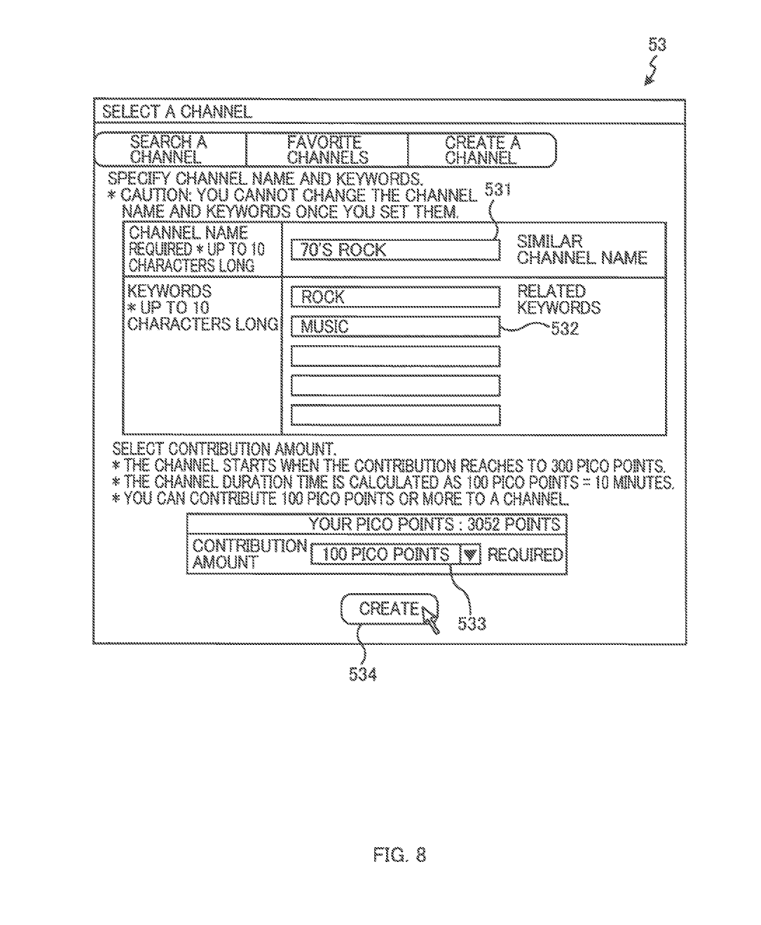

The channel-creation processing section 118 performs a process of creating a channel. FIG. 8 is a diagram showing an example of the screen 53 which is for inputting information related to the channel to be created. The screen 53 includes: an input field 531 for a channel name; and a plurality of input fields 532 into which keywords related to the channel are entered. In the present embodiment, creation of a channel needs a contribution of an amount corresponding to a predetermined opening time period (30 minutes in the present embodiment; that can be set freely), that is, a contribution of 300 units or more. If a contribution made at the time of creating a channel is less than 300 units, the channel cannot open (become a state in which users can chat) until the total contribution amount reaches 300 units. The screen 53 has the pull-down list 533 by which a user selects a contribution amount to pay for creating a channel. Here, a channel name is entered into the input field 531, keywords are entered into the input fields 532, a contribution amount is selected from a pull-down list 533, and a button 534 is pushed. Then, the channel-creation processing section 118 sets the following items to a command (hereinafter referred to as channel creation request) for requesting the creation of a new channel: the channel name, keywords, and the contribution which are entered on the screen 53; and a user ID. The channel-creation processing section 118 sends the command to the chat server 20. Thus, a new channel is created on the chat server 20.

### Chat Server 20

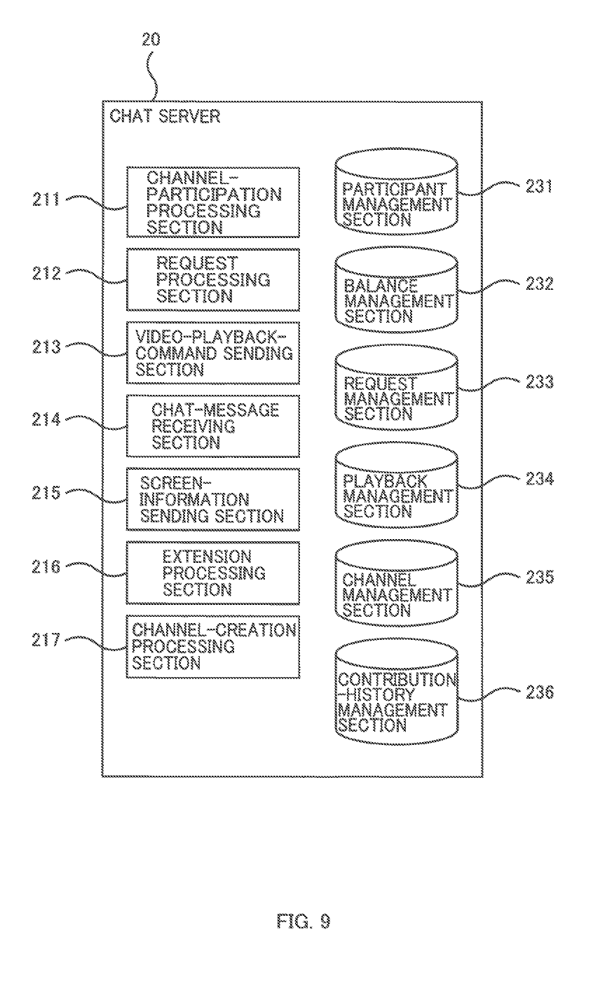

FIG. 9 is a diagram showing an example of the software configuration of the chat server 20. The chat server 20 includes a channel-participation processing section 211, a request processing section 212, a video-playback-command sending section 213, a chat-message receiving section 214, a screen-information sending section 215, a extension processing section 216, a channel-creation processing section 217, a participant management section 231, a balance management section 232, a request management section 233, a playback management section 234, a channel management section 235, and a contribution-history management section 236. Note that the foregoing operational sections 211 to 217 are realized by the CPU 101 in the chat server 20 which reads programs stored in the storage device 103 to the memory 102 and executes it. The foregoing storage section 231 to 236 are realized as a part of the storage regions which are provided by the memory 102 and the storage device 103 of the chat server 20.

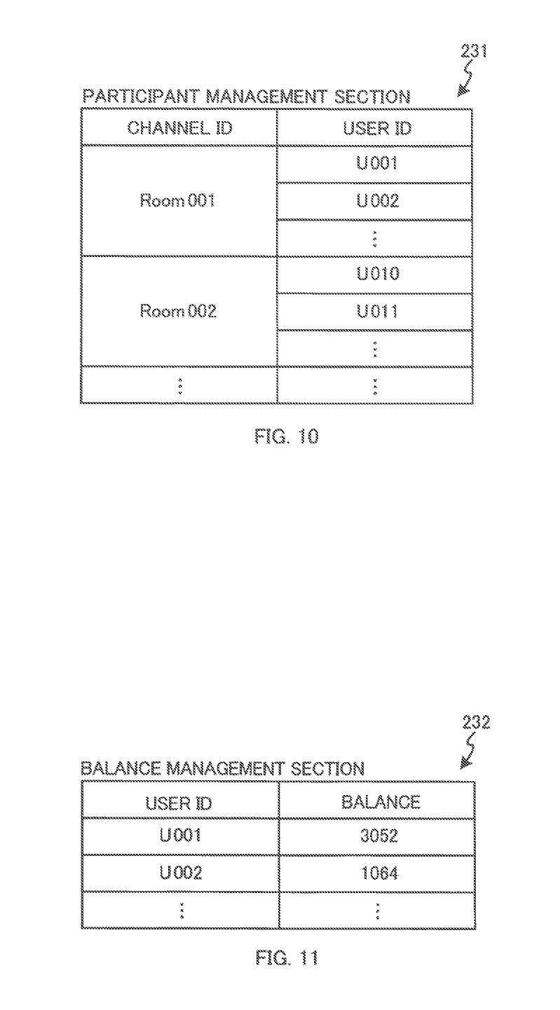

The participant management section 231 manages the users who participate in the channels. FIG. 10 is a diagram showing an example of the configuration of the participant management section 231. The participant management section 231 correlates, to a channel ID, the user IDs of the users participating in the channel and stores them.

The balance management section 232 manages the virtual currency balance belonging to users. FIG. 11 is a diagram showing an example of the configuration of the balance management section 232. The balance management section 232 correlates the balance of virtual currency to a user ID and stores it. In the present embodiment, the balance of virtual currency increases periodically by a certain amount.

The channel-participation processing section 211 performs a process for making user participate in a channel. When receiving a channel participation request from the user terminal 10, the channel-participation processing section 211 correlates the channel ID and the user ID contained in the channel participation request and then registers them to the participant management section 231. Thus, the user participate in the channel.

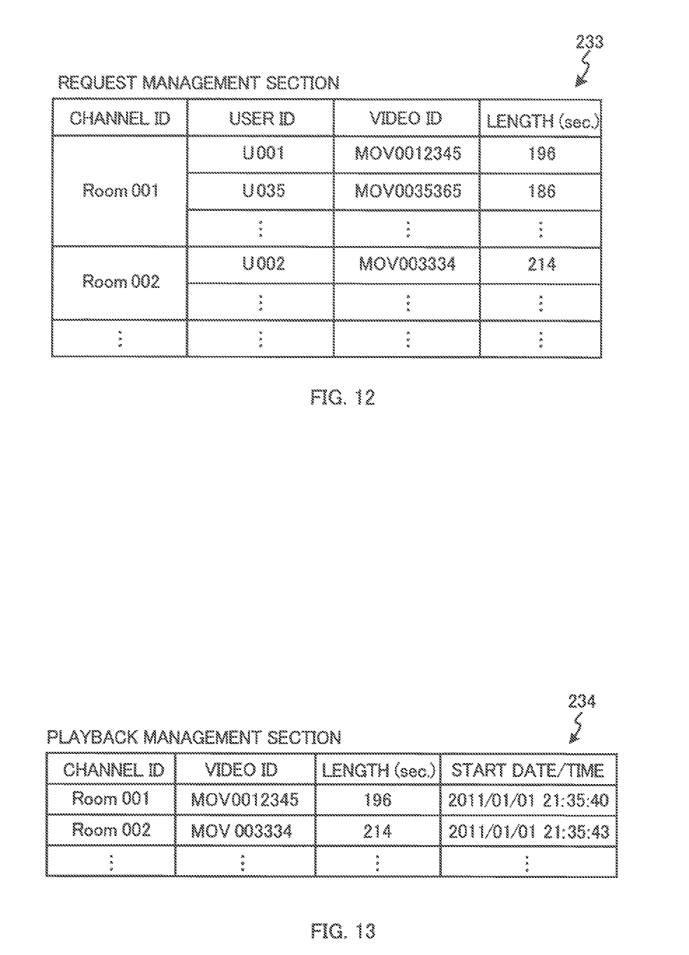

The request management section 233 manages the video requests from users. FIG. 12 is a diagram showing an example of the configuration of the request management section 233. A channel ID, a user ID, a video ID, and the length of a video are set to a request stored in the request management section 233. The length of a video is set by a request processing section 212 to be described later. In the present embodiment, in she request management section 233, a queue by which requests can be registered and retrieved in FIFO (FIRST IN FIRST OUT) order is created for each channel.

The request processing section 212 registers to the request management section 233 a video request (metadata acquired by a user from a video server: a video ID, the length of a video, and the like) sent from the user.

The playback management section 234 manages the videos which are playing on channels. FIG. 13 is a diagram showing an example of the configuration of the playback management section 234. The playback management section 234 correlates, to a channel ID, the video ID indicating a video in playing, the length of the video, and the starting time of a video playback (that is, the play date/time which is set to a video playback command) and stores them.

The video-playback-command sending section 213 sends a video playback command to the terminals 10 of the users who participate in a channel. When a video playback is finished, the video-playback-command sending section 213 sends to the user terminals 10 of all users who participate in the channel a video playback command in which the video ID contained in the next request and the current date/time are specified as the video ID and the play date/time. As a result, a same video plays concurrently on the user terminals 10 of ail users who participate in the channel. When a new user participates in the channel, the video-playback-command sending section 213 sends to the user terminal 10 of the new participant user a video playback command to which a video ID, the current date/time, and an offset are set; the offset is obtained by calculating a time from the start date/time stored in the playback management section 234 to the current date/time. Thus, on the user terminal 10 of the new participant user, the video plays in synchronization with the other participant users.

The chat-message receiving section 214 receives a chat-message sent from the user terminal 10.

The screen-information sending section 215 sends to the user terminal 10 screen information for displaying the screen of the user terminal 10. In response to reception of a chat-message, the screen-information sending section 215 sends to the terminal 10 of other users screen information, such as a message and actions of an avatar which are received as a chat-message. Also, when the operator side of the chat server 20 notifies ail users of a message, the screen-information sending section 215 sends that message as screen information. For example, when the opening time period is nearing the end in a channel, the screen-information sending section 215 can send to the user terminals 10 screen information so that the message that the channel is going to close soon is displayed on the screens of the user terminals 10.

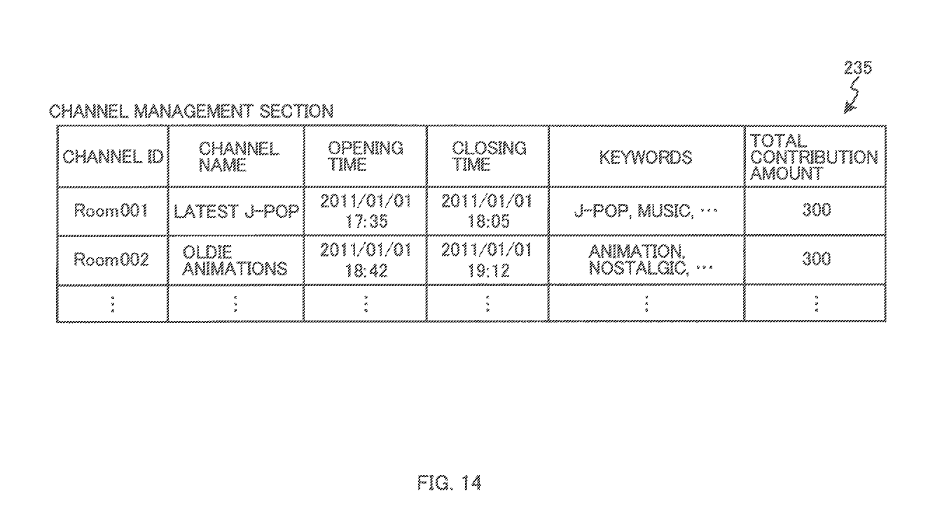

The channel management section 235 stores information related to the channels. FIG. 14 is a diagram showing an example of the configuration of the channel management section 235. The channel management section 235 correlates the following things to a channel ID and stores them: the name of the channel (channel name); the time at which the channel is created (opening time); the time (hereinafter referred to as a closing time; corresponding to the closing time point of the invention) at which the opening time period has passed from the opening time; keywords; and the total amount of virtual currency which users have contributed to the channel (total contribution amount).

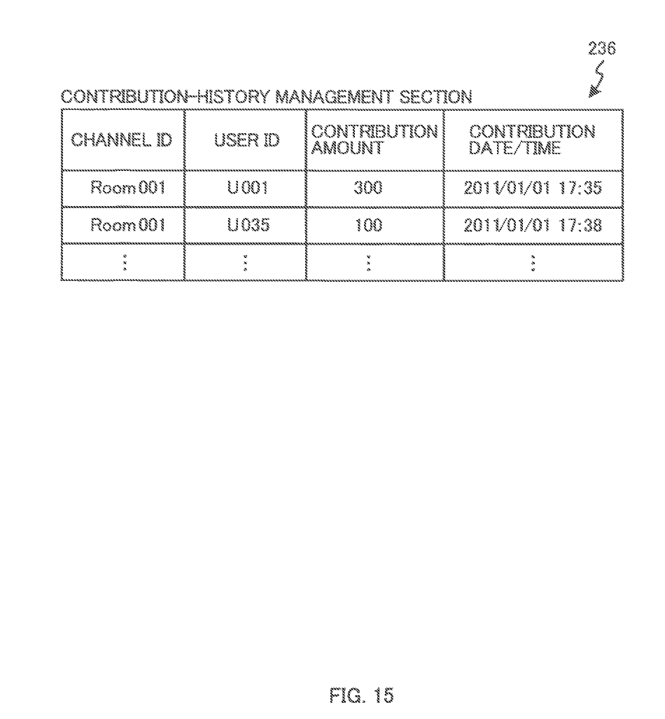

The contribution-history management section 236 manages histories of contributions by users. FIG. 15 is a diagram showing an example of the configuration of the contribution-history management section 236. The contribution-history management section 236 correlates the following items to a channel ID and stores them: the user ID of the users who have made contributions, the contribution amount and the date/time at which the contribution has been made.

The extension processing section 216 performs a process of extending the opening time period according to payment of virtual currency by a user to a channel. When receiving an extension request from the user terminal 10, the extension processing section 216 calculates extension time according to the contribution amount which is set to the extension request. In the present embodiment, a virtual currency of 100 units makes 10 minutes extension. Therefore, the extension processing section 216 calculates the extension time, in second, by multiplying 600 by the contribution amount divided by 100. The extension processing section 216 adds the extension time to the closing time of the channel management section 235 corresponding to the channel ID set to the extension request. In addition thereto, the extension processing section 216 adds the contribution amount to total contribution amount, and subtracts the contribution amount from the balance of the balance management section 232 corresponding to the user ID. The extension processing section 216 correlates the following items to the current date/time and registers them to the contribution-history management section 236: the channel ID, the user ID, and his/her contribution amount which are contained in the extension request.

The channel-creation processing section 217 performs a process related to creation of a channel. When receiving a channel creation request from the user terminal 10, the channel-creation processing section 217 generates a new channel ID and calculates an opening time period corresponding to the contribution amount (in the present embodiment, 10 minutes per 100 units as with extension). The channel-creation processing section 217 correlates the following things and registers them to the channel management section 235: the generated channel ID; the channel name which is set to the channel creation request; the current date/time; the closing time which is obtained by adding the opening time period to the current date/time; the keywords which are set to the channel creation request; and the contribution amount which is set on the channel creation request. Thus, a new channel is created. As mentioned above, if the contribution amount is less then 300 units, the channel-creation processing section 217 sets the opening time period to 0. If the total contribution amount corresponding to the channel ID which is set to the extension request is less than 300 units and the total contribution amount becomes 300 units or more after the contribution amount that is set to the extension request is added, the extension processing section 216 calculates the closing time by adding the opening time period corresponding to the total contribution amount to the current date/time, and the closing time is set.

### Processes for Chatting and Video Playback

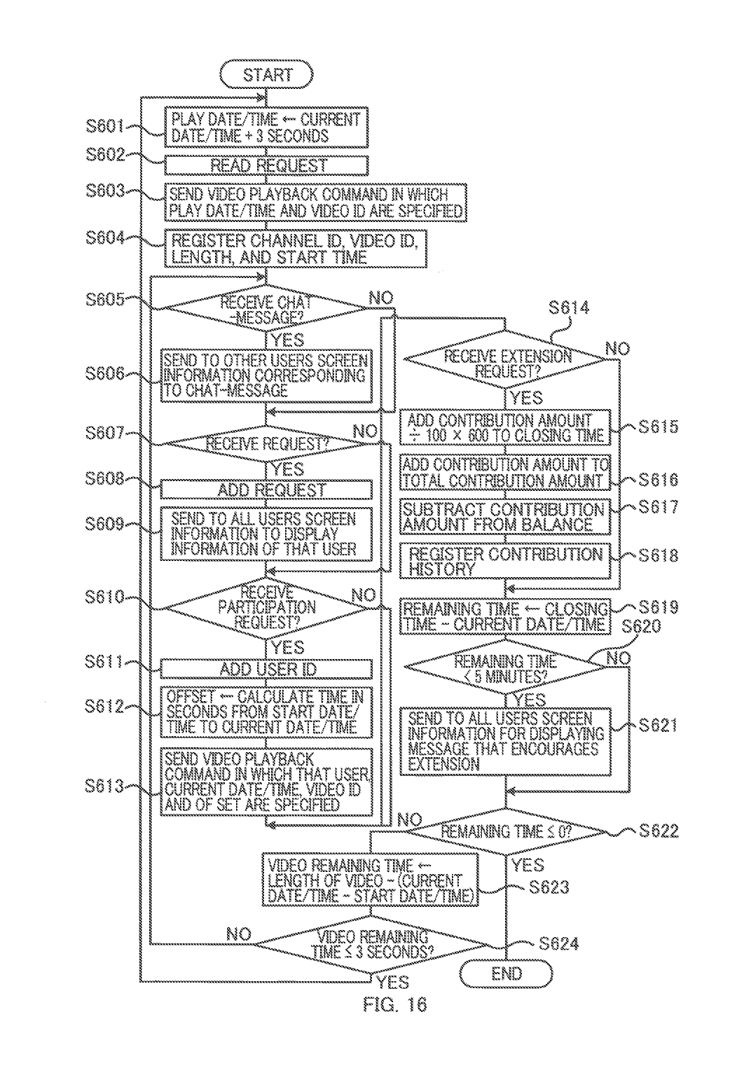

FIG. 16 is a flowchart showing processes of the chat server 20 relating to the chat service. Note that processes in FIG. 16 are performed for each of the channels.

The video-playback-command sending section 213 configures a play date/time to the date/time which is a predetermined period (in the present embodiment, 3 seconds; any length including zero is acceptable) after the current date/time (S601). The video-playback-command sending section 213 reads from the request management section 233 one request corresponding to the channel ID of that channel (S602). The video-playback-command sending section 213 sends a video playback command to the user terminals 10 of all users who participate in the channel, the video playback command being provided with the play date/time and the video ID contained in the request (S603). the video-playback-command sending section 213 correlates to play date/time the chancel ID, the video ID and the length which are contained in request, and registers them to the playback management section 234 (S604).

If the chat-message receiving section 214 receives a chat-message from the user terminal 10 (S605: YES), the screen-information sending section 215 sends screen information corresponding to the chat-message, to the user terminals 10 of the other users who are not that user (S606). If the chat-message includes a message, the screen-information sending section 215 seeds, as screen information, information for displaying that message in speech bubble 4 on the screen 1. On the other hand, if motion of the avatar is specified in the chat-message, the screen-information sending section 215 sends, as screen information, information for moving the avatar 3 of that user on the screen 1. Note that the screen information can be one which is used in chat services using general avatars.

If receiving a request (S607: YES), the request processing section 212 register the request to the request management section 233 (S608). As mentioned above, the request processing section 212 performs the registration after acquiring the length of video from the video distribution server 30 and setting it to the request. The screen-information sending section 215 sends, to the user terminals 10, screen information for displaying on the screen 1 a message that the request has been registered (S609). For example, in the example of FIG. 1, the avatar 8 of the user who made the request is displayed near the video 2; the screen-information sending section 215 sends to the user terminals 10 screen information for displaying the foregoing avatar 8. It is acceptable for a request to contain any information related to the request such as the title of a video, the artist's name, etc., and the screen-information sending section 215 may send to the user terminals 10 screen information for displaying these information.

If receiving a channel participation request which is provided with the channel ID of that channel (S610: YES), the channel-participation processing section 211 correlates the channel ID and the user ID contained in that channel participation request and registers them to the participant management section 231, which results in making the user participate in the channel (S611). It is acceptable that if the user ID contained in the channel participation request has already been registered to the participant management section 231, the channel-participation processing section 211 deletes the combination of the channel ID and the user ID from the participant management section 231. The video-playback-command sending section 213 acquires from the playback management section 234 the video ID and the start date/time corresponding to channel ID, and acquires an offset by calculating time in seconds from the start date/time to the current date/time (S612). Then, the video-playback-command sending section 213 sends to the terminal 10 of the sender of the channel participation request, the video playback command which the current date/time, the acquired video ID and the offset are set to (S613).

When receiving the extension request which the channel ID of that channel is set to (S614; YES), the extension processing section 216 calculates an extension time by first dividing by 100 and then multiplying by 600 the contribution amount which is set to the extension request. The extension processing section 216 adds the extension time to the closing time of the channel management section 235 corresponding to foe channel ID which is set on the extension request (S615). In addition, the extension processing section 216 adds the contribution amount to the total contribution amount (S616). The extension processing section 216 subtracts the contribution amount from the balance of the balance management section 232 corresponding to the user ID which is set to the extension request (S617). The extension processing section 216 correlates the following items to the current date/time and registers them to the contribution-history management section 236 (S618): the channel ID which is set to the extension request; the user ID; and contribution amount. As mentioned above, if the channel is closed, the extension processing section 216 sets the closing time of the channel management section 235 to the date/time which is the above-mentioned extension time after the current date/time.

The screen-information sending section 215 reads from the channel management section 235 the closing time corresponding to the channel ID of the channel, and obtains a remaining time by calculating time in seconds from the current date/time to the closing time (S619). If the remaining time is less than a predetermined threshold (5 minutes in the example of FIG. 16; any length is acceptable) (S620: YES), screen information for displaying a message that encourages extension is sent to the user terminals 10 of all users who participate in the channel (S621). For example, in the example of FIG. 1, the message “The channel will close in 3 minutes! Make the contribution for extension” is displayed; screen information to display such a message is sent at this stage.

If the remaining time becomes 0 or less (S622: YES), the processes end.

If the remaining time is greater than 0 (S622: NO), the video-playback-command sending section 213 acquires from the playback management section 234 the start date/time corresponding to the channel ID of the channel, and calculates a video remaining time by subtracting from the length of the video the time in seconds from the acquired start date/time to the current date/time (S623). If the video remaining time becomes 3 seconds or less (S524; YES), the process proceeds to the step S601; and the video relating to the next request plays. If the video remaining time is greater than 0 (S624: NO), the processes from the step S605 are repeated.

As mentioned above, with the chat system of the present embodiment, it is possible to limit the opening time period during which users can chat and to extend the opening time period by payment of a price in virtual currency by users. It can be considered that users are not motivated to make payment even in virtual currency if communication in their channel is not active. Therefore, it is possible to encourage extension of the opening time period of a channel in which communication is active, and closing (becoming a stage in which users cannot chat) of a channel in which communication is not active. This makes it possible to promote communication of the whole chat service.

Further, in the chat system of the present embodiment, while viewing a same video, a plurality of users who are participating in the same channel can exchange messages. Therefore, by providing a topic to the users from the video, the users become more likely to transmit messages. In addition thereto, it is likely that, on the same channel, videos of the same theme play. Therefore, it is expected that users whose taste is similar to each other assemble in a same channel. Communication is usually active between users whose taste is similar to each other, which makes it possible to promote communication.

In the chat system of the present embodiment, the chat server 20 is a system which is different from the video distribution server 30. Therefore, in conjunction with the video distribution server 30 providing a existing video distribution service, the chat server 20 can provide a chat service in which users can be chatting while viewing a video. This makes it possible to reduce the construction cost of the chat server 20. On the other hand, sending to the user terminals 10 a video playback command with the start date/time set to the time that is 3 seconds after the current date/time allows all user terminals 10 to synchronize their video playback. Further, in a channel in which a new user participates after the channel has started, it is possible to send the new user a video playback command with an offset that is set to the time which corresponds to the length of the video which has already being played. Thus, even when a new user participates in a channel in which a video has already started playing, the video plays on the user terminal 10 of the new user in synchronization with the other users.

In the present embodiment, price for extending the opening time period is paid by virtual currency. However, the invention is not limited thereto. The price may be paid by point assigned to users, in cash, or by credit with a credit card.

Further, in the present embodiment, a certain amount of the virtual currency is provided to each user periodically. However, the invention is not limited thereto. Any configuration may be employed. For example, users may purchase virtual currency, or virtual currency may be provided according to activities of users in the chat service or other SNSs (SOCIAL NETWORKING SERVICE). Also, virtual currency may be provided to a user according to the user's communication. In this case, if a greeting is made for example between the avatars 3, it is possible to provide virtual currency of a certain amount to the user corresponding to the greeted avatar 3. Also, the following configuration may be employed: a message can be sent to a specific user, and, when a message is sent to a certain user, virtual currency is provided to a user who received the message. Furthermore, the following configuration may be employed: an evaluation of a video can be entered, virtual currency is provided, according to the evaluation of a video, to the user who registered a request of a video.

Further, in the present embodiment, the video distribution server 30 distributes videos to the user terminal 10. However, the chat server 20 may distribute videos. In this case, the chat server 20 may have ail functions of the video distribution server 30. Otherwise, it is also possible that the chat server 20 downloads from the video distribution server 30 video data corresponding to the request, and the downloaded video data is distributed to each of the user terminals 10.

Further, in the present embodiment, the chat server 20 is a single computer. However, the chat server 20 may be configured by a plurality of computers. For example, the chat server 20 can consist of the following servers: a WEB server which receives from the user terminals 10 a channel participation request, a video request, a chat-message, an extension, request, and a channel creation request, and sends to the user terminals 10 an video playback command, screen information, etc.; a database server which constitutes a part or the whole of the storage sections 231 to 236 of the chat server 20; and an application server which performs a process of making a user participate in a channel, a process of adding a video request, a process for sending a video playback command, a process of generating screen information, and a process of channel extension and channel explanation.

Further, since the configuration of the chat server 20 in the present embodiment is a example, the number of the operational sections and the storage sections may be different. For example, the participant management section 231, line channel management section 235, and the contribution-history management section 236 may be one or two tables; and the request management section 233 and she playback management section 234 may be one table.

Furthermore, in the present embodiment, the channel management section 235 stores the closing times of channels. However, the closing times may be managed by storing the opening times and the opening time periods. In this case, it is possible for the extension processing section 216 to add an extension time to an opening time period of the channel management section 235 when users nave paid virtual currency.

It should be noted that the aforementioned embodiments are for facilitating understanding of the invention, and are not limiting of the invention, and are not to be interpreted as limiting the invention. The invention can of course be altered and improved without departing from the gist thereof, and equivalents are intended to be embraced therein.

What is claimed is:

1. A system that sends and receives a message to users belonging to a group, comprising:
a message transmission section that transmits the message among the users belonging to the group only until an opening time period has passed, the message being allowed to be sent and received during the opening time period;
a closing information storage section that stores, for each group, closing information for determining a closing time point at which the opening time period ends;
a payment-reception section that receives from a user a payment of a price to a specified group; and
an extension processing section that updates the closing information in response to the payment so that the closing time point corresponding to the specified group is delayed.

2. A message sending/receiving system according to claim 1, wherein
the payment-reception section acquires the group specified by the user and an amount of the price paid by the user, and
the extension processing section updates the closing information according to the amount of the price so that the closing time point is delayed.

3. A message sending/receiving system according to claim 2, wherein
the message sending/receiving system further comprises a balance management section that manages, for each user, a balance of a price payable by the user,
the payment-reception section receives a payment request from the user, the payment request including
a group specifying information that specifies the group,
a user specifying information that specifies the user, and
the amount of the price, and
the extension processing section
updates the closing information according to the amount of the price included in the payment request so that the closing time point is delayed, the closing information corresponding to the group specified by the group specifying information included in the payment request, and
subtracts the amount of the price from the balance corresponding to the user specified by the user specifying information included in the payment request.

4. A message sending/receiving system according to claim 1, wherein
the message sending/receiving system further comprises a video provider section chat provides a video to all of the users belonging to the group.

5. A message sending/receiving system according to claim 4, wherein
the message sending/receiving system further comprises a request-reception section that receives a request of the video from the user only until the opening time period has passed, and
the video provider section provides the video to the user according to the request.

6. A message sending/receiving system according to claim 4, wherein
the message sending/receiving system connects to a user terminal of the user and to a video distribution server that distributes the video,
the video distribution server is configured to transfer video data according to a video play request, and
the video provider section controls the user terminal so that the video play request which specifies the video is sent to the video provider server.

7. A message sending/receiving system according to claim 6, wherein
the video distribution server is configured to transfer video date that is on and after a playback-start time if the playback-start time is set on the video play request, the playback-start time being an elapsed time that has passed from a beginning of the video,
the message sending/receiving system further comprises
a control-history storage section that stores a time at which distribution of the video starts, and
a user management section that manages, for each group, the users belonging to the group,
the video provider section controls the user terminal by sending to the user terminal a command which instructs to send to the video provider server the video play request which specifies the video,
if a new user participates in the group,
the video provider section
reads from the control-history storage section the video-distribution-start time corresponding to that group,
calculates an elapsed time that has passed from the read video-distribution-start time to the current time, and
sends to a user terminal of the new user the command which instructs to send to the video provider server the video play request in which the calculated elapsed time is specified as the playback-start time of the video.

8. A method for assisting in sending and receiving of a message among users belonging to a group, by a computer having a processor and a memory, comprising:
transmitting the message to the users belonging to the group only until an opening time period has passed, the message being allowed to be sent and received during the opening time period;
storing, for each group, closing information for determining a closing time point at which the opening time period ends;
receiving from a user a payment of a price to a specified group; and
updating the closing information in response to the payment so that the closing time point corresponding to the specified group is delayed.

9. A non-transitory computer-readable storage medium storing a program that causes a computer having a processor and a memory to execute steps for assisting in sending and receiving of a message among users belonging to a group, comprising the steps of:
transmitting the message to the users belonging to the group only until an opening lime period has passed, the message being allowed to be sent and received during the opening time period;
storing, for each group, closing information for determining a closing time point at which the opening time period ends;
receiving from a user a payment of a price to a specified group; and
updating the closing information in response to the payment so that the closing time point corresponding to the specified group is delayed.
